(19) United States
(12) Patent Application Publication
(10) Pub. No.: US 2019/0374902 A1
(43) Pub. Date: Dec. 12, 2019

(54) Extracting Water From A Gas Mixture With An Absorption Unit In Combination With A Thermal Water Extraction System

(71) Applicant: SIEMENS AKTIENGESELLSCHAFT, Muenchen (DE)

(72) Inventors: Markus UNGERER, Baiersdorf (DE); Gerhard ZIMMERMANN, Höchstadt/Aisch (DE)

(73) Assignee: Siemens Aktiengesellschaft, Muenchen (DE)

(21) Appl. No.: 16/312,030

(22) PCT Filed: May 5, 2017
(86) PCT No.: PCT/EP2017/060788

§ 371 Date: Dec. 20, 2018

(30) Foreign Application Priority Data
Jun. 29, 2016 (DE) 10 2016 211 744.0
Jul. 11, 2016 (DE) 10 2016 212 566.4

(51) Int. Cl. B01D 53/14; B01D 53/26; B01D 53/28; B01D 1/06; B01D 1/14; E03B 3/28

(52) U.S. Cl. CPC B01D 53/1425; B01D 53/1418; B01D 53/263; B01D 53/28; B01D 2252/60; B01D 1/14; E03B 3/28; B01D 2252/103; B01D 1/065

(57) ABSTRACT

Various embodiments include a method for isolating water from a moist gas mixture comprising: absorbing water in an absorption medium disposed in an absorption unit; separating the water from the loaded absorption medium in a thermal water isolation plant; and regenerating the absorption medium in the thermal water isolation plant with temperatures of less than 100° C. prevailing in the thermal water isolation plant.

### CROSS-REFERENCE TO RELATED APPLICATIONS

This application is a U.S. National Stage Application of International Application No. PCT/EP2017/060788 filed May 5, 2017, which designates the United States of America, and claims priority to DE Application No. 10 2016 211 744.0 filed Jun. 29, 2016 and DE Application No. 10 2016 212 566.4, filed Jul. 11, 2016, the contents of which are hereby incorporated by reference in their entirety.

### TECHNICAL FIELD

The present disclosure relates to a process and an apparatus for isolating water from a gas mixture by means of an absorption unit in combination with a thermal water isolation plant.

### BACKGROUND

In some regions of the world, there is too little drinking water available today. This problem will increase significantly in coming years. The reasons for this are firstly climate change and secondly population growth and economic growth. Up to the year 2020, the water requirement is expected to increase by 40%. One possible way of producing drinking and process water in the vicinity of the coast is the desalination of seawater. The drinking and process water is usually produced from the seawater by means of reverse osmosis. However, this technology produces large amounts of salt-rich concentrate as waste. This salt-rich concentrate is frequently disposed of by introduction into the sea, where it causes great environmental damage.

A possible alternative way of isolating water from the sea, in particular for isolating drinking water, is the isolation of water from the air. The isolation of drinking water from air can be carried out by means of various techniques. The technology which is most frequently used at present is cooling of the moist gas mixture on a surface to below the dew point of water by means of an electrically powered refrigeration machine. However, this technology has a high power consumption since the water content of air at ambient temperature is very low and part of the cooling energy is required to cool the carrier stream of air.

A further possible way of isolating water from air is the use of desiccants. Liquid or solid components can serve as desiccants. The desiccant is then loaded with water by absorption or adsorption. The loaded desiccant, the absorbent or adsorbent, can subsequently be regenerated by supplying energy. However, the commercial processes for isolating water from air have a specific power consumption of about 500 kWhₑₗ/m³ of drinking water produced, which is disadvantageously two orders of magnitude above the energy consumption of a seawater desalination plant (about 5 kWhₑₗ/m³).

### SUMMARY

The teachings of the present disclosure may enable a process and/or an apparatus which makes energy-efficient isolation of water from a gas mixture possible. For example, some embodiments may include a process for isolating water from a moist gas mixture (2), wherein water (6) is absorbed in an absorption medium (17) in an absorption unit (16) and the water (6) is separated off from the loaded absorption medium (18) in a thermal water isolation plant (5) and the absorption medium (18) laden with water (6) is regenerated in the thermal water isolation plant (5), with temperatures of less than 100° C. prevailing in the thermal water isolation plant (5).

In some embodiments, the method includes: absorption of water from the moist gas mixture (2) in the absorption medium (17) in the absorption unit (16), introduction of a carrier gas (12) and of the water-laden absorption medium (18) into an evaporator (10), conveying of the loaded absorption medium (18) and the carrier gas (12) in countercurrent in the evaporator (10), as a result of which the carrier gas (12) is heated in the evaporator (10) and takes up a first component from the water-laden absorption medium (18), introduction of the carrier gas (13) laden with the first component into a first condenser (11), and condensation of the first component from the carrier gas (13) in the first condenser (11).

In some embodiments, the first component is water or the absorption medium.

In some embodiments, the regenerated absorption medium (17) is recirculated to the absorption unit (16) and/or fresh absorption medium is fed into the absorption unit (16).

In some embodiments, the first condenser (11) cools the loaded carrier gas (13) by means of the loaded absorption medium (18).

In some embodiments, humid air (2) or an offgas is used as gas mixture.

In some embodiments, hygroscopic salts in aqueous solution are used as absorption medium (17).

In some embodiments, lithium, calcium, or potassium halides are used as hygroscopic salts.

As another example, some embodiments include an apparatus for recovering water from a gas mixture by means of an absorption unit (16) in combination with a thermal water isolation plant (5), comprising: at least one absorption unit (16) for absorbing water from a gas mixture into an absorption medium (17), an evaporator (10) for operation using loaded absorption medium (18) and a carrier gas (12), where the evaporator (10) is configured for conveying the loaded absorption medium (18) and the carrier gas (12) in countercurrent and the carrier gas (12) is heated in the evaporator (12) and takes up a first component from the water-laden absorption medium (18) and the absorption medium (18) is regenerated and cooled, and a first condenser (11) for condensing the first component from the loaded carrier gas (13).

In some embodiments, the first component is water (6) or the absorption medium.

In some embodiments, the evaporator (10) is a falling film evaporator or a downflow evaporator.

In some embodiments, the evaporator (10) and/or the absorption unit (16) comprise packing.

In some embodiments, there is a storage facility (9) for collecting the regenerated absorption medium (17).

### BRIEF DESCRIPTION OF THE DRAWINGS

Further embodiments and further features of the teachings herein will be explained in more detail with the aid of the following figures. These represent an illustrative embodiment and combination of features which does not imply any restriction of the scope of protection. The figures show:

FIG. 1 a water isolation plant with dehumidifier and regeneration plant incorporating teachings of the present disclosure;

FIG. 2 a regeneration plant in combination with an absorption unit incorporating teachings of the present disclosure; and

FIG. 3 an overview of the process steps for the isolation of water incorporating teachings of the present disclosure.

### DETAILED DESCRIPTION

In some embodiments, a method for isolating water from a moist gas mixture by means of an absorption unit in combination with a thermal water isolation plant, water is firstly absorbed from a gas mixture into an absorption medium in the absorption unit. The water is subsequently separated off from the water-laden absorption medium in the thermal water isolation plant. The water-laden absorption medium is concentrated and thus regenerated in the thermal water isolation plant. Temperatures of less than 100° C. prevail in the thermal water isolation plant.

In some embodiments, the method combines the isolation of water by means of an absorption medium and the subsequent regeneration by thermal separation in a particularly energy-efficient way. The temperatures in the thermal water isolation plant are less than 100° C. and are thus so low that the thermal separation process can be carried out in an extremely energy-efficient way and many possible heat sources can be taken into consideration. This advantageously makes it possible, particularly in sunny regions, to obtain the heat in a decentralized manner by solar heating.

In some embodiments, both the thermal separation and also the absorption may operate either continuously or discontinuously. This can be particularly advantageous in phases of dryness or in phases of high solar irradiation when the heat for the thermal separation process is obtained from solar energy.

In some embodiments, the process for isolating water from a moist gas mixture comprises the following steps: firstly, water is absorbed from the moist gas mixture by the absorption medium in the absorption unit. The water-laden absorption medium and a carrier gas are then introduced into an evaporator. In the evaporator, the loaded absorption medium and the carrier gas are conveyed in countercurrent, with the carrier gas being heated in the evaporator and taking up a first component from the water-laden absorption medium. The carrier gas laden with the first component is fed into a first condenser where the first component condenses from the carrier gas.

The pressure in the thermal water isolation plant may be ambient pressure, e.g. in a range from 0.5 bar to 1.7 bar. Compression of the carrier gas or of the absorption medium is thus avoided, which makes the process energy-efficient.

In some embodiments, an apparatus for isolating water from a gas mixture by means of an absorption unit in combination with a thermal water isolation plant comprises at least one absorption unit for absorbing water from a gas mixture into an absorption medium. The apparatus further comprises an evaporator for operation with loaded absorption medium and a carrier gas, where the evaporator is configured for conveying the loaded absorption medium and the carrier gas in countercurrent. The carrier gas is heated in the evaporator and takes up a first component from the absorption medium. The absorption medium is regenerated and cools down. In some embodiments, the apparatus further comprises a first condenser for condensing the first component from the carrier gas.

Conveying the carrier gas and the loaded absorption medium in countercurrent in the evaporator advantageously makes it possible for the first component to be separated off at temperatures of less than 100° C., so that heat sources which would otherwise find no further use or only a low-value further use can be used. The absorption and the thermal separating process in the evaporator are therefore combined in an energy-efficient way and allow energy-efficient isolation of water from a moist gas mixture by means of an absorption medium.

In some embodiments, the first component is water or the absorption medium. In the regeneration operation in the evaporator, the water may be evaporated and taken up by the carrier gas and the absorption medium is thus regenerated. A high quality or high purity of the water can be ensured in this way. In some embodiments, the absorption medium may have a greater volatility than water. In some embodiments, the absorption medium can be ammonium carbonate, which is hygroscopic and nonvolatile at ambient temperatures. At temperatures above 60° C., ammonium carbonate decomposes into ammonia and carbon dioxide, with ammonia and carbon dioxide going over into the carrier gas in greater amounts than water. In this case, regeneration is carried out by the loaded absorption medium being taken up by the carrier gas in the evaporator and water being left behind.

In some embodiments, the regenerated absorption medium is recirculated to the absorption unit. The consumption of absorption medium is advantageously kept small in this way, which makes the process more efficient.

In some embodiments, the carrier gas laden with water or with the absorption medium is cooled in the first condenser by means of the loaded absorption medium as coolant. This minimizes the thermal energy required and thus improves the energy balance of the process.

In some embodiments, humid air or an offgas is used as gas mixture. Particularly in hot regions with little water, the temperatures are so high that the required drinking water can be isolated from ambient air since the hot ambient air can take up significantly more water than cold air. However, it is likewise possible to isolate water from offgases. Offgases from the paper industry or power station industry in particular have a high moisture content. Furthermore, these offgases have already been heated to temperatures higher than ambient temperature, so that the water content of the offgas can be significantly above the water content of ambient air. Although condensation of this water from offgases can be affected by cooling, the water then comprises further condensed components, in particular nitrides and sulfates from nitrogen oxides and sulfur oxides. However, if the offgas is subjected by means of the process to absorption in combination with the evaporator, mostly or exclusively water is absorbed when the absorption medium is appropriately chosen and further work-up of the water present downstream of the evaporator may be avoided or simplified.

The water from ambient air, which has been obtained by means of the conventional process by cooling to below the dew point, also has to go through further work-up steps so as to attain a satisfactory purity corresponding to commercially available water, especially in a private household. Decentralized, especially in private households, membrane filtration units are mostly used for further purification since these can be constructed more compactly with smaller volumes than thermal treatment plants. However, these membrane filtration units may have a high maintenance requirement and, at high concentrations of desiccants, are also less efficient in respect of yield and consumption of electric energy than suitable thermal treatment plants. For this reason, when there is sufficient required space, both in centralized and decentralized plants, the water may be isolated from the air with an absorption medium and the subsequent thermal water isolation plant. In some embodiments, hygroscopic salts in aqueous solution are used as absorption medium. Lithium, calcium, or potassium halides may be used as hygroscopic salts. In this case, the water is evaporated into the carrier gas during regeneration of the absorption medium in the evaporator. As a result of these salts not being volatile and having a low vapor pressure, it can be ensured that the quality of the condensate from the carrier gas is high.

In some embodiments, inorganic salts, salts of short-chain organic acids, and/or ionic liquids or other relatively nonvolatile compounds are also used as absorption medium.

In some embodiments, the evaporator is a falling film evaporator or a downflow evaporator. In this embodiment, the surface between the absorption medium and the driving gas is advantageously made very large, as a result of which the process can be operated in an energy-efficient manner.

In some embodiments, the evaporator and/or the absorption unit comprise packing. The use of packing, in particular fixed packing or beds of random packing elements, increases the interface between the carrier gas and the absorption medium. This promotes mass transfer and heat transfer so that the process can be carried out in a particularly energy-efficient manner. Furthermore, the droplet size can in this way be made larger than, in particular, in the case of spraying-in or misting. This minimizes the discharge of desiccant from the loading tower, which has a substantial positive influence on the economics and energy balance of the process.

In some embodiments, the apparatus comprises a storage facility, in particular a tank, for storing the regenerated absorption medium. The purified absorption medium from which moisture has been removed can be stored until it is once again introduced into the absorption unit.

In some embodiments, the first condenser is operated using the cool loaded absorption medium. The absorption medium is in this case may be preheated and can thus be introduced at a higher temperature than ambient temperature into a heat exchanger upstream of the evaporator. This reduces the additional heat to be introduced and represents an extremely energy-efficient apparatus.

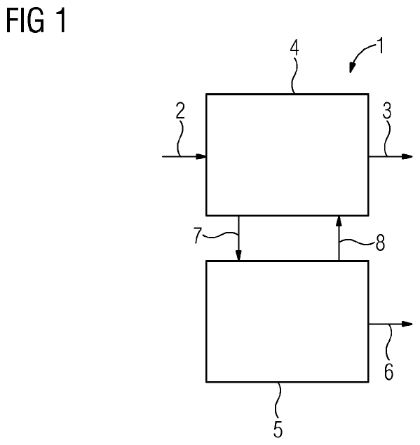

FIG. 1 schematically shows an overview of a water isolation plant for isolating water from ambient air. Above a specific atmospheric humidity of about 13 g_{water}/kgₐᵢᵣ, which corresponds to a relative atmospheric humidity of 100% at 10° C., water can be isolated from the ambient air by going below the dew point. Particularly in a region encompassing up to 4000 km north and south of the equator, corresponding conditions are present throughout the year. In these regions of the world in particular, it is therefore possible to isolate water, in particular drinking water, from the ambient air. If a process based on desiccants is used for isolating water, water can also be isolated down to a specific atmospheric humidity of 2 g_{water}/kgₐᵢᵣ, which is especially relevant in desert regions having a low atmospheric humidity.

The water isolation plant shown in FIG. 1 comprises a dehumidifier 4 and a regeneration plant 5. Humid air 2 is fed to the dehumidifier 4. In the dehumidifier 4, the ambient air is dried by means of desiccants, absorption medium or adsorption medium. The dry air 3 can subsequently leave the dehumidifier 4. The desiccant 7 loaded with water from the surroundings is then fed into the regeneration plant 5. There, the water 6 is isolated by means of a thermal separation process from the desiccant, in particular the absorption medium or adsorption medium. The regenerated desiccant 8 can be conveyed back into the dehumidifier 4.

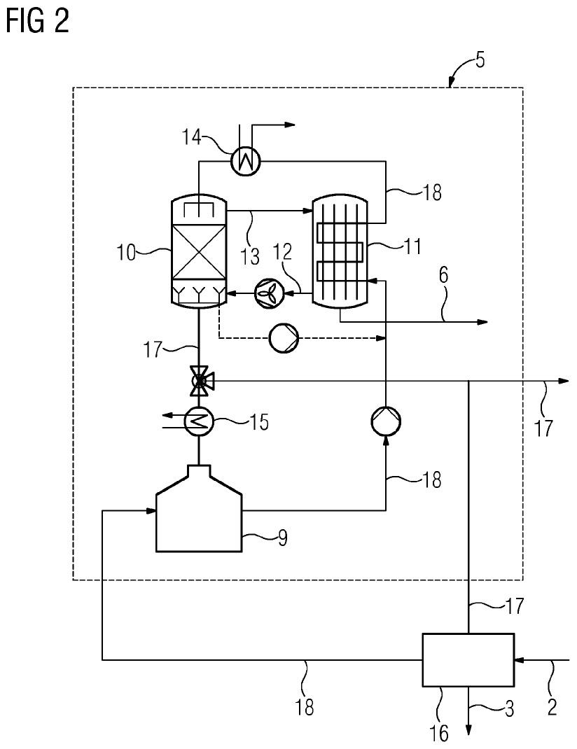

In order to make the recovery of the water 6 from the desiccant 7 as energy-efficient as possible, an evaporator 10 in combination with a carrier gas 12 may be used. This is shown in FIG. 2. The regeneration plant 5 is shown in detail in FIG. 2. Furthermore, an absorption unit 16 is used as dehumidifier 4. The humid air 2 is dried in the absorption unit 16 and leaves the absorption unit 16 as dry air 3. The water-laden absorption medium 18 is conveyed from the absorption unit 16 into the regeneration plant 5. There, it can firstly be collected in a tank 9. It is likewise conceivable for the loaded absorption medium 18 to be conveyed directly to a first condenser 11 and subsequently be preheated by means of a heating apparatus 14 in order for the loaded absorption medium 18 subsequently to be sprinkled in the evaporator 10. A dry carrier gas 12 is conveyed in countercurrent to the loaded absorption medium 18 in the evaporator 10. The dry carrier gas 12 is typically air. However, other gases are likewise conceivable. In particular, nitrogen and monoatomic ideal gases (noble gases He, Ne, Ar) are possibilities because of their low molar heat capacity.

The water-laden carrier gas 13 may be subsequently fed into the first condenser 11. There, it is cooled by means of the loaded absorption medium 18 so that water 6 condenses out. The loaded absorption medium 18 is conveyed in countercurrent to the loaded carrier gas 13 in the first condenser 11. The water 6 which has been condensed out is subsequently discharged from the plant. It already has a sufficient purity to correspond to drinking water quality but has to be enriched with salts in order to be used as drinking water. The water 6 which has been condensed out can also, depending on the desired field of use, subsequently be fed into a further purification stage. Activated carbon filters in order to remove organic substances are conceivable here. Furthermore, salts or traces of salts can be removed by means of electrodialysis or ion exchange techniques, e.g., ion exchange chromatography.

The regenerated absorption medium 17 leaves the evaporator 10 at the bottom of the evaporator 10 and is either conveyed back into the absorption unit 16 or discharged from the plant. The use of an evaporator 10 makes it possible for the thermal purification of the absorption medium 18 to take place at below 100° C. The process works according to the principle of convectively assisted evaporation of water in a downflow evaporator with air flowing in the opposite direction. That is to say, air can frequently be used as carrier gas 12. The condenser 11 is preferably cooled by means of absorption medium 18 in order to ensure efficient utilization of the available heat. The temperature of the downward-flowing loaded absorption medium 18 decreases from the top to the bottom of the evaporator 10 because heat is withdrawn from the loaded absorption medium 18 by evaporation and heat transfer and is transferred to the carrier gas 12, namely air. The temperature of the air flowing in the opposite direction increases from the bottom to the top of the evaporator 10, but in stable operation with steady-state conditions always remains below the temperature of the loaded absorption medium 18 at the same height in the evaporator 10. As a result, heat is transferred from the descending loaded absorption medium 18 to the ascending carrier gas 12, and correspondingly the ascending air can take up water from the loaded absorption medium 18. The absorption medium 18 and the carrier gas 12 thus form a countercurrent heat exchanger.

In some embodiments, for the purposes of internal heat recovery, the regenerated absorption medium 17 can optionally be used as cooling medium in addition to the loaded absorption medium 18 in the condenser 11. Before recirculation of the regenerated absorption medium 17 to the absorption unit 16, the regenerated absorption medium 17 can be cooled to a required temperature by means of a cooling unit 15.

In some embodiments, the evaporator 10 can comprise structured packing. The absorption unit 16 can also comprise structured packing. The same structured packing material can be used in separate units, namely the evaporator 10 and the absorption unit 16, in order to bring the ambient air into contact with the absorption medium at significantly lower temperatures in the absorption unit 16 compared to the evaporator 10 and thus ensure efficient loading of the absorption medium 17 with water from the ambient air by means of a large exchange surface. The loaded absorption medium 18 is then fed to the evaporator 11. The process can be operated continuously or discontinuously. Typically, an aqueous solution of strongly hygroscopic salts having a low volatility, in particular lithium, calcium, or potassium halides, is used as absorption medium. In the regeneration operation in the evaporator 10, the water is typically evaporated and the absorption medium is thus regenerated. As a result of the use of nonvolatile salts, a high quality of the water, i.e. a high purity corresponding to drinking water quality, of the water can thus be ensured.

In some embodiments, the absorption medium 17 may have a lower vapor pressure than water and thus a greater volatility than water. In particular, the absorption medium 17 can be ammonium carbonate which is hygroscopic and nonvolatile at ambient temperatures. At temperatures above 60° C., ammonium carbonate decomposes into ammonia and carbon dioxide, with ammonia and carbon dioxide going over into the carrier gas 13 in greater amounts than water. In this case, the regeneration in the regeneration plant 5 occurs by loaded absorption medium 18 being taken up from the carrier gas 13 in the evaporator 10 and water being left behind.

In some embodiments, the salts of short-chain organic acids can be used as absorption medium having a significantly lower vapor pressure than water; short-chain acids are, in particular, acids having from one to three carbon atoms. The vapor pressure of the salts of these acids should advantageously be so far below the vapor pressure of water that good separation of the absorption medium can be effected.

Possible ways of affecting the degree of separation of water from the absorption medium can be, independently of the vapor pressure of the absorption medium, the setting of a defined pH. As a result of setting of the pH, the absorption medium is then converted into a less volatile form as a function of the acid-base equilibrium. Furthermore, it is possible to carry out a multistage process for regeneration. Both possibilities for regeneration of the absorption medium can be operated at temperatures below 100° C., so that the required heat can be obtained in a decentralized manner by means of solar heating in hot sunny regions. Obtaining the heat by means of solar heating makes an environmentally friendly process having a reduced CO₂ footprint possible.

A further possible way of exploiting heat and water sources is the utilization of offgases. Offgases from the paper industry or the power station industry in particular comprise water. Offgases which usually already have a significantly higher temperature than the ambient temperature can take up significantly greater amounts of water compared to ambient air at room temperature. For the present purposes, room temperature is considered to be a temperature in the range from 10° C. to 30° C., in particular from 15° C. to 25° C.

If water is isolated from an offgas, the absorption medium has to be selected in such a way that only water is absorbed and no other substances, in particular nitrates or sulfates, are absorbed. If these substances are absorbed, a further treatment step is necessary, depending on how the substances behave during the regeneration. If these substances go over into the product water in the regeneration, this water has to be treated further. If the substances remain in the absorption medium during the regeneration, this absorption medium accordingly has to be treated further.

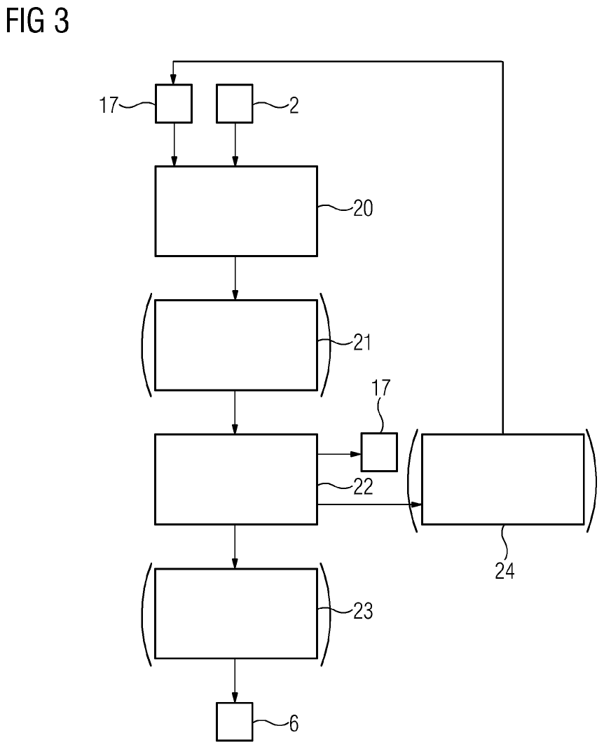

FIG. 3 schematically shows the process for isolating water from ambient air. Firstly, humid air 2 and an absorption medium 17 are fed into a dehumidifier 4 where the absorption 20 of water from air 20 takes place. The absorption medium can subsequently optionally be preheated 21 by means of the carrier gas 13. Regeneration 22 of the loaded absorption medium 18 subsequently takes place. The regenerated absorption medium 17 can subsequently be conveyed back into the dehumidifier 4. However, it can also be partly taken directly from the process. Furthermore, the water can be purified 23 after regeneration of the absorption medium 22. Thus, pure water, in particular water which can also be processed further as drinking water, leaves the plant.

What is claimed is:

1. A method for isolating water from a moist gas mixture, the method comprising:
absorbing water in an absorption medium disposed in an absorption unit;
separating the water from the loaded absorption medium in a thermal water isolation plant; and
regenerating the absorption medium in the thermal water isolation plant with temperatures of less than 100° C. prevailing in the thermal water isolation plant.

2. The method as claimed in claim 1, further comprising:
absorbing water from a moist gas mixture in the absorption medium in the absorption unit;
introducing a carrier gas and the water-laden absorption medium into an evaporator;
conveying of the loaded absorption medium and the carrier gas in countercurrent in the evaporator to heat the carrier gas in the evaporator and add a first component from the water-laden absorption medium to the carrier gas;
introducing the carrier gas laden with the first component into a first condenser; and
condensing the first component from the carrier gas in the first condenser.

3. The method as claimed in claim 1, wherein the first component is water or the absorption medium.

4. The method as claimed in claim 1, further comprising recirculating the regenerated absorption medium to the absorption unit.

5. The method as claimed in claim 1, further comprising cooling the loaded carrier gas in the first condenser with the loaded absorption medium.

6. The method as claimed in claim 1, wherein the gas mixture comprises humid air or an offgas.

7. The method as claimed in claim 1, wherein the absorption medium comprises hygroscopic salts in aqueous solution.

8. The process as claimed in claim 7, wherein the absorption medium comprises at least one substance selected from the group consisting of: lithium, calcium, and potassium halides.

9. A system for recovering water from a gas mixture, the system comprising:
an absorption unit for absorbing water from a gas mixture into an absorption medium;
an evaporator using loaded absorption medium and a carrier gas, the evaporator configured to convey the loaded absorption medium and the carrier gas in countercurrent, wherein and the carrier gas is heated in the evaporator and takes up a first component from the water-laden absorption medium and the absorption medium is regenerated and cooled; and
a first condenser to condense the first component from the loaded carrier gas.

10. The system as claimed in claim 9, wherein the first component comprises water or the absorption medium.

11. The system as claimed in claim 9, wherein the evaporator comprises a falling film evaporator or a downflow evaporator.

12. The system as claimed in claim 9, wherein at least one of the evaporator and the absorption unit comprises packing.

13. The system as claimed in claim 9, further comprising a storage facility to collect the regenerated absorption medium.
